(19) United States
(12) Patent Application Publication
(10) Pub. No.: US 2014/0269516 A1
(43) Pub. Date: Sep. 18, 2014

(54) INTERNET, CELLULAR BROADCAST PHONE SET AND SOFTWARE

(71) Applicant: Jennipher Adkins, Chicago, IL (US)

(72) Inventor: Jennipher Adkins, Chicago, IL (US)

(21) Appl. No.: 14/299,521

(22) Filed: Jun. 9, 2014

Related U.S. Application Data
(62) Division of application No. 12/480,481, filed on Jun. 8, 2009.
Application No. 12/480,481 is a continuation of application No. 10/403,901, filed on Apr. 1, 2003, now abandoned.
Application No. 10/403,901 is a continuation-in-part of application No. 09/733,830, filed on Dec. 11, 2000, now abandoned.

(51) Int. Cl. H04M 7/00

(52) U.S. Cl. CPC H04M 7/006
USPC 370/328; 370/352

(57) ABSTRACT

Internet, cellular, wireless communication broadcast device that functions with software application that provides a means to utilize the internet, make telephone calls via an always connected ISP and cellular service provider. Touch screen base, mobile devices and remote devices can create, receive, store content submitted by broad cast software application and camera use. Broadcast software provides a targeted medium to send content to a network of recipients. All devices comprise wireless technologies (i.e. Bluetooth, satellite, cellular) that provide a means to switch telecommunication functions between the base device and mobile device to the technological advantage of the user. Thus allowing alternating functionality of the mobile device

### CROSS-REFERENCE TO RELATED APPLICATIONS

This application is a divisional of co-pending U.S. Non-Provisional application Ser. No. 12/480,481, filed Jun. 8, 2009, which is a continuation of U.S. Non-Provisional application Ser. No. 10/403,901, filed Apr. 1, 2003, which is a continuation-in-part of U.S. Non-Provisional application Ser. No. 09/733,830, filed Dec. 11, 2000. The contents of U.S. Non-Provisional application Ser. No. 12/480,481, U.S. Non-Provisional application Ser. No. 10/403,901, and U.S. Non-Provisional application Ser. No. 09/733,830 are hereby incorporated by reference in their entirety.

### FIELD OF INVENTION

The invention relates to a base and mobile device for receiving and transmitting telephony signals and audio/visual content, via wireless and land-based technologies that maintain constant internet and telephony interconnectivity between mobile unit, base unit and other remote devices. User can also utilize land based technologies when mobile device is within proximity to base device. Mobile unit has wireless technologies that receives and transmits video signals via integrated camera to base unit. Base and mobile devices operate in tandem with broadcast software, whereby the device interface allows the end user to interact with content created and disseminated by a back end user.

### BACKGROUND OF INVENTION

The current invention has various objectives with regard to Internet usage, the Plan-Old-Telephone System (POTS), cellular phone service, wireless connectivity and visual communication using an internet device. Currently, the primary way to utilize phone services offered via the Internet, one must purchase a computer, a separate headset, logon to the Internet then access telephone website or interface. The user must close or minimize other applications and/or otherwise alter their computer screen in order to make a call using a Internet based telephone technology (Le. VOiP).

### DESCRIPTION OF RELATED ART

In order to provide back ground information so that the invention may be completely understood and appreciated in proper context, research was conducted for prior art. U.S. Pat. No. 6,169,734 BI, issued Jan. 2, 2001, Wilson, offers Internet access using the Plain Old Telephone System platform. This invention's Internet access is via a dial-up connection and is not always on, nor does it offer the ability for back-end and front-end users to create, view, respond and archived broadcasted media, camera usage or wireless communication. Nor does said invention provide an uninterrupted power supply (UPS) as a form of backup power. Nor does this invention offer the ability to create, maintain or access, via an external menu (DAM Menu), user settings, functions and features as present invention does. Nor does this invention maintain a constant Internet connection, provide a mobile device that functions both as a cell phone and a regular hand set.

### OBJECTS AND ADVANTAGES

The present invention comprises: a base and mobile telephony device that allows constant access to the Internet, (i.e. via DSL, satellite microwave, and/or other methods), provides self service Broadcast Software application platform whereby a backend user can create, and an end user can view, customized broadcasted announcements and advertisements (announcement/ad), email and Internet access via integrated Internet Service Provider (ISP) software, web hosting of announcement/ads, a web browser, wireless communication and VOiP technologies. Other features and functions include access to call history, text messages, scrollable voice mail, calendar, address book and a control panel to manage an array of other user settings. This is partially achieved with a Broadcast Software application (“BS”), a web browser, an Internet Service Provider (“ISP”), hosting services and telephony technology such as DECT (Digital Enhanced Cordless Telecomunications), TOMA (Time Division Multiple Access), ADPCM (Adaptive Differential Pulse Code Modulation), DCS/DCA (Dynamic Channel Selection/Allocation) the GAP profile, to ensure interoperability of equipment from different providers. The Broadcast Software can function as a virtual web based application, thereby freeing memory space within the base unit.

Broadcast Software will provide businesses, government and individuals Broadcast Announcement/ad Capabilities (“BAC’) twenty-four hours a day. Broadcast Software will comprise of pre-designed templates that will allow the creator to complete a series of steps for self service production, dissemination and management of custom announcements and ads that will broadcast onto the displays (i.e. base unit, mobile unit or personal computer) using Internet Protocol (IP) addresses, telephone numbers or other identifiers of the end user. Broadcast content can include yellow page entries, advertisements, notices, invitations (via streaming media, text message, email or calendar entry). Web portals will also be recipients of Broadcast Software productions that will be accessible from a personal computer when a URL (Universal Resource Locator) is searched on WWW (World Wide Web). Broadcast software will have, but not be limited to the ability for the back-end user to create an announcement/ad to be broadcasted by selecting a 1.) page template, 2.) demographics relative to who will see the announcement/ad based on their personal data and/or their location; 3.) “run” time schedule relative to how long, time(s) of day, number of views (if applicable) and; 4.) broadcast allocation areas on base unit and mobile display and storage. For example, the back-end user/business entity will have options as to where part or all of their announcement/ad's information can appear. The front-end user opts-in to what is viewed on their respective base and/or mobile device. To illustrate, an advertisement can appear in multiple areas 1.) as a ticker stream on the home screen; 2.) as a full ad in a directory section; 3.) and as a text message, among other areas. The back end user's payment to the service provider will be determined by the various parameters chosen when creating and disseminating the announcement/ad. Broadcast software will also allow an entity to send individual updates to their recipients or customers, track performance and usage of current and past announcement/ads, make payments and complete other electronic business functions currently in use in today's market. Broadcast Advertising Interaction (“BAI”) allows the front-end user (customer) to interact with content shown on their display(s) by responding or replying to viewed media, making a purchase, requesting information, saving announcement/ads or becoming a customer by joining a mailing list.

Above functions are combined with telephone components, where phone calls can be made and received via constant Internet access or the Public Switched Telephone Network (“PSTN”) or land based method, wireless service or broad band (VOiP).

Conversely, service providers will realize a significant, new revenue stream as business entities and individuals use this new hardware/software combination to create and update yellow page directory information, create entries for auxiliary category directories (i.e. as a current phone book is indexed), streaming media ads, classified ads, invitations, pharmaceutical reminders, bill payment reminders and other fee based announcements and advertisements. For example pizza delivery offers, dry cleaning specials and other local businesses are anticipated to use this affordable yet highly relevant medium of finding and maintaining customers.

A Direct Access Menu (“DAM”, i.e. which provides users external push button access to functions and features from base and mobile units such as Call Logs, Personal, Yellow Pages and Announcement/ad Directories, Security Settings, Purchases/Billing/Payment Index). Mobile unit is an Internet ready, mobile device that provides wireless or cellular telecommunication within proximity to base unit.

Same device is communicably connected with base unit via a wireless connection (i.e. technology like “Blue Tooth” or similar). Whereby, incoming and outgoing calls no longer access wireless telecommunication (cellular) network to be completed, by utilizing telephony connection of base unit, thereby conserving minutes by minimizing cellular use when the mobile device and base unit are near each other.

Utililizing the internal control panel, the the base unit also serves as the gateway between the service provider and end user, whereby customer service and updates can originate from the base unit, thereby allowing for more self service capabilities for the end user. The is especially relevant in managing an address book, photos and various messages.

Mobile device also provides access to a camera component, announcement/ads, email and other telephone functions. Devices offered by base and mobile units are but are not limited to: internal .high speed modem, microprocessor, RAM memory, wireless communication receiver and transmitter, Universal Power Supply (“UPS”) and other elements for operating and storing content. Base unit provides ac/dc cord, telecommunications cord, peripheral ports (i.e. for external key board, monitor, cell phone charger, palm charger) combined with other standard components necessary to achieve this invention. The mobile unit also comprises a re-chargeable battery.

When utilizing current invention's dual telecommunication ability, users can now use their home phone mobile unit as their cell phone and vice versa. The base and mobile units communicate via a wireless technologies telecommunication median to be used for incoming and outgoing calls based on the proximity of the devices. Users can also have additional, uniquely identifiable mobile units that are all synced to the base unit. These mobile units can contain different telephone numbers and IP addressees for family members. Multiple mobile units that contain different telephone numbers and IP addressees can be utilized for dedicated purposes (i.e. a dedicated home based “mobile unit” for the home number and an alternative cellular “mobile unit” for the cellular number). Whereby, contact information, text messages and the like within the mobile device can now be transferred with ease to the base unit. The fear of loosing ones data in a lost or stolen mobile hand set will be done away with.

When utilizing the current invention's camera component, users can surveille an area with ease. The user only has to position a mobile device consisting of camera component in the area to be watched. Images will appear on display of base unit or other receiving unit. The mobile device can be a hand set or other transmitting device. The base unit also comprises a camera for video conference abilities.

In emergency situations, this device can serve as an emergency information center by utilizing its UPS system in the event of a power outage. Users will still have access to important instructions and updates offered via ISP and Broadcast Software (Internet or intranet) for as long as the backup power lasts.

As a communication median, the Internet is efficient and cost effective for mass reachability. The current invention provides an optimal means to search targeted disseminated information locally, nationally and internationally.

By using this invention, shopping could be encouraged by offering a revolving line of credit with telephone service. Using the Broadcast Software, users could apply purchases to their telephone bill, in addition to other methods of completing a purchase. For example, hotels can use the present invention to allow guests to order room service or other products and services, receive concierge services, or check out. The broadcast software provides a way to disseminate relevant information to households or to multiple unique customers with one building via the phone set, whereby an end user can interact. Other business and institution uses can include schools, hospitals and general office.

The present invention adds technology to an existing device that will remove the void that is creating a tremendous forfeiture of revenue from nonexistent sales. Even today, in too many areas, this technology void has been termed the “Digital Divide” (“DD”). The present invention addresses the Digital Divide (“DD”) by combining Internet access and the ability search and purchase from an always on, accessible, streaming advertisements and broadcasted media via a household device, the telephone, while combining cellular phone usage and management. A personal computer is not needed to interact with the present invention.

End users can opt to customize what appears on their display by selecting or “opting in” desired content to be streamed on their various displays (i.e. important email alerts, date/event alerts combined with photos, breaking news and stock prices, or even which business entity is advertising, the lowest cost of milk). Whichever manner the end user selects to access announcemenVads, this invention gives users the ability to search the Broadcast Software database (i.e. indexes and directories) for goods and services, complete a purchase, store information in a personal directory and maintain a purchase history record. By broadcasting content on the current invention, companies, government entities and others can now target the most relevant target market for their message. For example, when a front-end user (also referred to end user) attempts to make a long distance telephone call, using the easily accessible (“DAM”) menus, they would now be able to compare broadcasted or advertised long distance rates by multiple carriers and complete the call using the best selection, as this search could be carried out for all products and services.

Having a UPS, would especially be important during emergencies or power outages because it would provide full power to the base device for a period of time, whereby business entities can send urgent messages, information and instructions.

The Direct Access Menu (“DAM”) of this invention also combines functions such as easy access to call history, personal, local, national, international and various broadcast content directories and other features such as the ability for the end user to program user settings, save favorited or regularly needed announcements (or company access),pay bills, view past purchases, receive and pay bills, control panel and view a Customer service area.

The present invention will acclimate low to middle income households to the efficiencies of using the Internet at home. Primarily because they will not be required install programs, decide which hardware or software to purchase or learn how to operate a complicated device. This invention addresses device preparation for federal legislation that has been mandated that requires homes built after 2010 be wired with multimedia, fiber optic cabling as a standard.

There are other objects and advantages in the specification and drawings. There is nothing on the market that offers the same benefits as present invention does.

### SUMMARY OF INVENTION

It has been found that prior telecommunication systems using the Internet have limited functions and do not provide broadcasted announcements specifically targeted for individuals or offer dual land based, cellular functionality. As such, a primary objective of the present invention is to provide a device that integrates hardware components of a base device with mobile units and mobile units and a Broadcast software application that has constant access to the Internet, that disseminates targeted broadcasted media and provides easily accessible telephone functions and features. In this regard, a device which supports the latest Internet audio protocol standards for all phones provided. In one embodiment, the present invention defines an Internet telephone with an internal modem that remains connected to the Internet.

Present invention has an integrated, touch command display with integrated interface that renders content, visual call progress information to the user as well as other communications indicators and other relative information simultaneously. The touch screen keyboard and toggle keypad also comprises navigational tool to navigate the visual interface to content as it appears on display.

Another object of the present invention is to provide a device that can be used to make voice connections via the PSTN and digitally compressed audio using the Internet protocol. Internet access is constant on present invention. User may program device to utilize Internet telephone service providers network in base unit to access broadcasted content of business entities using Broadcast Software.

Another object of the present invention is to offer front-end users the ability via Broadcast Software to receive, view and save real time broadcasted content on multiple devices. Also with the ability to respond, purchase and research incoming activities (content, announcement/ads that appear as instructed by the back end user in various non-streamed or dormant locations.

Another object of the present invention is to offer back-end users the ability to produce and disseminate content, announcement/ads to a super targeted audience based on 18 parameters using Broadcast Software sending content to displays of base and mobile units of current invention.

Another object of the present invention is to provide business entities (i.e. . . . companies, government entities and others) the ability to access web based Broadcast Software at anytime, to create content, announcement/ads to be disseminated to the public via present invention using the Internet.

Another objective of current invention provides for a national, household emergency communication device comprising of Internet access, a display and UPS backup in the event main power is lost, and/or the there is an urgent message to be broadcasted from the National Emergency Broadcast System and where telephone service or wireless telephone communication is still intact. There are various ways users may utilize present invention to contact others when main power is lost which consists of land line telecommunication, Internet based telecommunication, wireless telecommunication(i.e. when Internet and/or telecommunication signal is via satellite) and via sending and receiving email messages.

Yet another object of current invention is to offer back-end users/business entities the ability to create a default announcement/ad in the event telephone service interruption. This service mode will allow pre-paid calls to be made until normal service is restored. Interrupted service mode will also allow for emergency communication.

Another object of the present invention is to provide users the ability to control access and maintain security by adding “User Settings” by accessing the control panel area. This will enable users to select from a menu on how to manage their account, set timings, customize their base and mobile unit displays, create their individual profile, identified by their Internet protocol (“IP”) address and their telephone number. Additionally, the control panel will also manage the camera settings, phone synchronization and other management capabilities.

Yet another object of the present invention is to provide a mobile unit has wireless communication means with base unit in which both share and provide the same information on respective displays and within storage areas. Mobile unit will also feature push button access that allows user to switch functions of the device. Mobile unit will also provide a camera to capture and transmit images to base unit or a remote receiver.

Yet another object of the present invention is to provide a base unit that allows multiple mobile units to be simultaneously charged to re-establish security protocols for security measures, access limitations, and information updates. Multiple mobile units can also sync with the base unit to exchange data.

Yet another object of the present invention is to offer a hand-set and mobile unit that will provide both wireless and cellular telecommunication. When mobile unit enters a receiving range to base unit it can switch from cellular based telecommunication to non-cellular based telecommunication to complete calls, whereby calls received by or made from mobile hand set are administered by the base unit Alternatively, when it exits same range, mobile unit will seek telecommunication from another means (i.e. cellular, satellite, etc.), thereby accessing cellular service. Base and mobile unit can maintain relationship based on dedicated access numbers stored in base unit. There by allowing base unit to be moved within certain locations while still providing full telecommunication services to end-user.

Another objective to present invention is to create an intuitive filing system when responding to and storing information accessed base unit or hand set, whereby purchases, text messages, contacts and past history will be stored in respective areas for later retrieval.

Another object of present invention is to provide service providers additional unique ways to indentify users on their network. For example, in addition to a telephone number, the customer can also be granted an alternative identification (this identifier could be a portion of the customer's telephone number, but not entirely), so that others can quickly and easily indentify and communicate with the customer using the present invention.

For a more complete understanding of the present invention, including features and advantages, reference is now made to the following detailed description, taken in conjunction with the accompanying drawings and diagrams.

### BRIEF DESCRIPTION OF DRAWINGS

FIG. 1 illustrates a prior art of an Internet Phone;

FIG. 2 is a top.side view of the Internet, Cellular Broadcast Phone Set device according to the present invention; and

FIG. 3 is a detailed circuit diagram for the Internet, Broadcast Phone according to the invention; and

FIG. 4 is a detailed flow chart for Broadcast Software application for back-end users; and

FIG. 5 is a detailed flow chart for Message Button, announcement/ad access for front-end users; and

FIG. 6 is a detailed flow chart for Directories Button, announcement/ad access for front-end users; and

FIG. 7 is a detailed flow chart for Display access to announcement/ad for front end users; and

FIG. 8 is a detailed flowchart for Purchase/Billing Button announcement/ad access for front-end users. Corresponding numerals refer to corresponding parts in the figures unless otherwise indicated.

### DETAILED DESCRIPTION

In FIG. 1 an Internet phone from prior art is shown. Turning now to FIG. 2, a two component touch screen version of the Internet, Cellular Broadcast phone set device in accordance of the present invention is shown. The set also has some functions of a standard Plain Old Telephone System (“POTS’). The top component of the base unit 13 comprises of a primary touch screen display and a camera 35. The bottom component of the base unit comprises a touch screen display 12, menu 14,16,18,19,20,21, toggle keys for keypad 72 and keyboard 74, mouse 23, speakers 22, stylus 76,78, charge and synchronization stations for multiple mobile units 70, a power cord 34 and Ethernet cable 36.

The method of use of current invention utilizes software programs (i.e. ISP software, hosting software, telecommunication software and broadcast software) and communication technologies (i.e. Broadband, PSTN, Cellular, wireless communication) See FIGS. 4-8).

The base unit 13 and mobile unit 65 houses various telecommunications devices as herein described and as can be appreciated by those skilled in the art. Accessible from the top surface 15 of the base 13 are various buttons and input devices which is one way to operate the Internet, Cellular, Broadcast phone set.

A keypad button 72, toggles with alphanumeric keyboard button 74 to provide touch screen devices using same surface area 12, 38 of base unit 13. The numeric keypad 72 device provides identical Dual Tone Multifrequency (“DTMF”) push button operation similar to a POTS. Virtual alphanumeric keyboard 74 provides QWERTY type interface which the user can enter alphabetic and numeric entries and messages to be included in the Internet message stream. The Alphanumeric keyboard 74 device functions as an input device of a typical desktop computer.

A stylus is attached 78,67 onto physical base 13 and onto one side of mobile mobile unit 65 and facilitates the-operation of the touch screen displays 12,30,38. User can also accomplish same by the use of a finger or other object by applying pressure. When stylus is not in use, it may be stored in receptacle 76,69. A Navigation Control Center on touch screen display 80 allows user to navigate corresponding information as it appears on Display 12,30,38. As shown, the mobile unit 65 receives communication capabilities via being communicably integrated to the base 13 by wireless communication.(i.e. Blue Tooth, microwave, DSL, direct satellite connection) and telecommunication devices (cellular, satellite)and/or other external wireless communication connections as herein described and as can be appreciated by those skilled in the art.

The mobile hand set 65 also comprises a 12,30,38 and a camera 35.

The touch screen display 30 hand set (also referred to as the “mobile unit”) 65 comprises a camera 35, an earpiece 27 and a mouthpiece 29. Mobile unit 65 can be used to transmit and receive signals, which are digitized and processed for transmission onto provider(s) network(s) and with the base unit 13.

The multi-dock charging and synchronization cradle 70 (base unit and mobile unit can also synchronize wirelessly) can provide power to multiple mobile units 65. Mobile unit 65 comprises internal software (not shown) to provide full operational, navigational and camera 50 use.

Push buttons 56,59,60,63 are shown on side 64 of mobile unit that provides external control to operational modes and functions of mobile unit. An “E” button 56 located on side of mobile unit 64 is pressed for immediate access to email functions via virtual menu (not shown) appearing on mobile unit display 30.

A “C’ button 58 located on side of mobile unit 64 is selected for immediate access to camera functions via virtual menu (not shown) appearing on mobile unit display 30. User may also access camera functions 58 and camera lens 50 by flipping up lowered lens SO to the “on” position.

A “T” button 60 allows immediate access to telephony functions via virtual menu (not shown) appearing on mobile unit display 30. Volume control while mobile unit is in use can be controlled by press “up” arrow or “down” arrow on external volume adjuster 63. Multi-cradle charger 70 will provide a charging station for mobile unit 65. To do so, user may connect mobile unit to charging area. Mobile unit may also be charged using a standard AC/DC adapter.

Mobile unit modes' 61 back-end functionality may overlap (i.e. to service incoming email when user is in telephone or camera mode). User may also customize display 30 of mobile unit to give comprehensive updates of features that can be shown on its display 30 when phone is idle (i.e. number of calls missed, new mail received or if sent mail has been opened, type of telecommunication in use). Similarly, the same customization can be done on base unit display 38. The control panel within the user settings 40 can manage the displays and the functionality 12, 38, 30 of the base unit 13 and mobile unit 65.

A microphone 24 located on face 15 provides for the transmission of audible signals from user. Speaker 22 located on lower base 15 provides for the reception of audible signals to the user. Alternatively, audio signals can be received and transmitted via mobile unit 65.

Integrated displays 12, 30,38 is provided to give the user visual information about the current Internet connection and any other information. Display 12, 30,38 allows viewing access to virtual prompts including keypad 12A,30A for dialing numbers and alphanumeric keyboard UB,30B for text input.

Prompts and indications for functions initiated from face 15 of base unit will appear on Primary display 38. Prompts and indications for functions initiated from mobile unit 28 will appear on mobile unit display 30. Alternatively, user can opt for the visual content of the base display 38 and mobile unit display 30 match.

The display screen 38 can show visual response when a button is pushed on a Direct Access Menu (“DAM”) 43. Direct Access Menu (“DAM”)43 buttons 39,40,42,44, 48,46A,46B can have various features accessible from the physical base unit 15. The same features can all be accessed from the touch screen menu.

When a Direct Access Menu (“DAM”) 43 button 39,40,42,44, 48,46A,46B is pressed, the corresponding virtual menu appears (not Shown) on base unit display 38. Navigation Control Center 80 allows user to navigate corresponding information as it appears on base unit display 38.

A “Message button” 39, may provide but not be limited to access to email, voice and text messages received via Internet protocols and the ability to navigate, manage and respond to same. The “Message button” 39, also allows front end user to access individualized quick notes (i.e. for example the pharmacist would have the ability to send a notification that a prescription is ready using an identifier other than an email address, such as phone number, account number) created by back end user with Broadcast Software, (see FIG.5 for front-end usability, FIG. 4 for back-end usability).

A “User Settings” button 40 will provide but not be limited to security Code management, system set up, user setup, ringer type selection, language setting, email set-up, trouble shooting instructions, calculator, calendar/planner, direct access to customer service and the ability to customize display and any other standard management features currently used today on a personal computer and cellular phone 30,38.

A “Calls” button 42 may provide but not be limited to call logs (i.e. incoming, outgoing with date and time) and the ability to dial directly from log using the navigation and selection function of the navigation control center 80 (touch screen). The “Call” button 42 also allows user to forward incoming calls to a desired number after inputting security code.

A “Favorites” button 44 will allow users to store (broadcasted) content for easy access. This is especially important when time sensitive content has expired from the network. The “Favorites” section can be accessed from an exterior button or the touch screen display.

A “Directories” button 48 provides but not be limited to allowing the user the ability to input, save and view contact information within a personal directory. The telephone number and the email address fields in a personal directory are accessible using the touch screen navigation and selection operations. The “Directories” button 48 also provides access to an “Online Yellow Pages and White Pages,” (not shown) web based directory. Directories button 48 also allows front end user to access indexed announcements created by back end user with Broadcast Software, organized by category, state, and priority base on announcement cost (see FIG.6 for front-end usability, FIG. 4 for back-end usability), whereby multiple directories created by category is created.

A “Purchase/Billing,” button 46A,46B allows user to maintain and view payment and billing logs. Purchase page 46A allows front end user to view payment transactions including receipts, order confirmations, shipping information, and overall historical payment record for all transactions. Billing page 46B allows service provider a location to send bill and user to view bills by accessing a monthly Bills Calendar. End user can also pay bills and maintain a list of various accounts that can also indicate balances, updated by backend user of Broadcast Software by the respective business entities (see FIG. 8 for front-end usability, FIG. 4 for backend usability).

Payment for purchases can be debited to telephone bill or a prearranged monetary account or purchases can also be completed by other standard and acceptable methods.

Central data base (not shown) housed in memory of physical base of unit (not shown) and in memory of mobile unit (not shown), can mutually update when new information via wireless communication that has been entered (i.e. telephone book entry, call logs, email history) when both are in proximity and/or when mobile is re-docked in docking station 70. Present invention will also have means for remote telephonic access to central database for the retrieval of information accessible from the base unit.

To complete land based calls, user may input phone number using dial pad UA by access in the menu from the touch screen. User may also press “calls” button 42 on DAM 43, or “T’ button 60 on mobile unit 28.

User may also select a specific VOiP Internet call provider by pressing “Calls” button 40 on DAJ.\.f or “T” button on hand set 60 or “INT” button 19 shown on face 15 of physical base 13.

User may then select from an internal list of broadcasted carriers (business entity) that have created a specialized announcement or interface using Broadcast software (see FIG. 4) that broadcasts their most current prices on display 30,38.

Commonly used telephone features such as flash button 14 for call waiting, redial button 16, mute button 18, INT button 19 (for Internet services), call forward button 20 and speaker button 21 is provided on 15 base unit.

FIG. 3 is a diagram that shows how the base unit and mobile units operate and how they intercommunicate using wireless and high speed internet connectivity, whereby data is exchanged, managed and stored.

Referring now to FIG. 4, a broadcast software application flow chart is shown. Broadcast software allows back-end user to create broadcast content, announcements/ads to be accepted via Internet, Cellular, Broadcast Phone Set and shown on displays base 30 and mobile 38 units. For example, a business entity, or individual must first register 204 before accessing menu functions 214 of Broadcast Software. Using pre-made templates 222 (templates will be categorized and indexed to offer back end user a selection to choose from), an announcement/ad is created 216 using Broadcast Software, created with images, streamed media or just text 224, the recipient or who will receive the announcement/ad 226 (i.e. create discreet announcement for bills, confirmations, invitations for individuals, specified customers or recipients) and “nesting” location or where will the content reside for front-end accessibility (i.e. nesting refers to where the announcement/ad is instructed to appear for end user viewing, for example, when a business entity or individual creates an announcement/ad, per the dissemination instructions 237, that content can appear on the primary displays 30,38″ in the “Directories” 48 page, within the “Message” 39 area and/or “Purchase/Bills” 46 page, and/or other proprietary web portal area. Back-end user can also select other functions from menu 214 that comprise, but are not limited to, account management, customer data base management (i.e. this area can provide demographic, buying history or proprietary customer listings), competitive tracking reports, receipt confirmations, logistical tracking and payment section. After back-end user has completed necessary steps to create the announcement/ad 222,224,226,228, an initial creation of announcement/ad is sent to a customer service support group 230 before it is disseminated to the public via base 38 and mobile unit 30. This function will serve as a “check,” for misspellings, vulgarities and obvious mistakes and to serve as a confirmation of the validity of the announcement/ad to ensure a responsible business entity or individual authorizes the transaction and agrees to all terms, conditions, fees relative to what will be broadcasted.

If no changes are made to the first draft, the business entity accepts and confirms announcement/ad 234. The dissemination choices can now be selected 237, whereby back end user will have a host of options of who will receive the content, within what areas on the displays it will appear and where it will be stored. Payment is then arranged for the broadcast and hosting service 238.

Moving now to FIG. 5 a flow chart of how messages and Ad/Announcements are accessed by an end user, whereby the back end user can (i.e. pharmacy, library or service repair) can send general reminders or announcements to multiple recipients/customers and the front end user (the customer) will receive the content via text, email and or voicemail message. To begin, end users will have the option to “opt-in” on how they will receive broadcasted content For example broadcasted content can be streaming media that appears on base unit display 38 and mobile unit display 30. However, the end user may opt to have these displays exhibit other content. The end user can always access broadcasted content by manually entering the area 248, 250 (broadcasted content can be nested in the directories area, online area, text message etc. . . . ). The end user can interact with the broadcasted content 252, or can just save 258 the content in a favorite 44, 260 section. (Note: broadcasted content may have an expiration date, if the announcement/ad is “favorited” 44, the end user will be able to access if after it has expired from the network.

If a purchase is made, or a call or message was sent to the business entity or individual who sent the announcement/ad, these respective actions will auto save in their respective areas thereby allowing for proper future tracking of events 262.

Based on the user settings, end user can require an access code 251 to retrieve messages.

FIG. 6 shows a flowchart of how an end user can access the various directories that are accessible from base unit mobile units. is “favorited” 44, the end user will be able to access if after it has expired from the network.

If a purchase is made, or a call or message was sent to the business entity or individual who sent the announcement/ad, these respective actions will auto save in their respective areas thereby allowing for proper future tracking of events 284.

Based on the user settings, end user can require an access code 272 to access the directories area.

The flowchart shown in FIG. 7 is similar to FIG. 5, with the addition of access to internet browser access 296, whereby users can browse the internet (see FIG. 22). This area also addresses the additional areas where back end user can disseminate content and therefore where the front end user can search (i.e. auxiliary directories, proprietary selling areas on the service provider's network.

The broadcast software will allow for a host of opportunities for business entities and end users will connect. The flow chart shown in FIG. 8 shows how a user can respond to and manage bills received (in coming) 334 and payments and purchases made (outgoing) 31 using the broadcast software. This feature will be especially helpful in recording, storing and retrieving receipts for all transactions that originate from base or mobile units 318. Other functions 316 can also include having a stored value, connected to service provider, a bank, other financial institution or payment method, whereby the user can easily make purchases, safely without the need to constantly read from a card each time a purchase or payment is made. An itemization of all transactions will appear when the user receives their respective bill from the service provider. The stored value can also be pre-paid.

Although the present invention has been described above with reference to preferred embodiments thereof, many variations, modifications and adaptations thereof, will become apparent to those skilled in the are which embody the concepts disclosed by the present invention. Accordingly, all such variations, adaptations, etc. are deemed to be part of the invention which is further defined by the claims recited below.

1-15. (canceled)

16. A method of broadcasting content, the method comprising:
receiving, with a processor, an end user selection of desired content to be displayed by a display, wherein the desired content comprises at least one of an advertisement or an announcement;
selecting, with the processor, the desired content to be displayed on the display in response to receiving the end user selection;
outputting, with the processor, the selected desired content to the display; and
displaying, with the display, the selected desired content.

17. The method of claim 16, further comprising: outputting, with the processor to the display, a login to a broadcast software before receiving the end user selection of the desired content.

18. The method of claim 16, further comprising: determining, with the processor, if changes to the content are desired.

19. The method of claim 16, further comprising: selecting, with the processor, one or more pre-designed templates for the display of the selected desired content.

20. The method of claim 16, wherein the display is one of a plurality of displays, the method further comprising: determining, with the processor, which of the plurality of displays to display the selected desired content.

21. The method of claim 16, further comprising: determining, with the processor, one or more broadcast allocation areas upon which the selected desired content will appear.

22. The method of claim 16, further comprising:
streaming in, with the processor, the selected desired content from over the Internet for output to the display.

23. The method of claim 16, further comprising:
searching, with the processor, for good or services in response to a user input from an end user that identifies the goods or services to be searched.

24. The method of claim 16, further comprising:
receiving, with the processor, a request to make a purchase from an end user.

25. The method of claim 16, further comprising:
receiving, with the processor, a request to save the desired content from an end user.

26. The method of claim 16, further comprising:
receiving, with the processor, updates to the selected desired content for display.

27. The method of claim 16, wherein the end user selection of desired content is received through broadcast software being executed by the processor, wherein the broadcast software functions as a virtual web based application.

28. The method of claim 16, wherein the display is located in a hotel.

29. The method of claim 28, further comprising:
receiving, with the processor, a service request from the end user, where the service request comprises one of a request for room service or a request for concierge service.

30. The method of claim 16, wherein the display is located in one of a school, a hospital, or a general office.

31. The method of claim 16, further comprising:
outputting, with the processor, a default advertisement or a default announcement.

32. The method of claim 16, wherein the announcement comprises a plurality of indexed announcements, and wherein the plurality of indexed announcements are organized by category, state, and priority.

33. The method of claim 16, wherein displaying the selected desired content comprises displaying, with the display, the selected desired content as one of: a ticker stream, a full advertisement in a directory section of the display, or as a text message.

34. The method of claim 16, further comprising:
tracking, with the processor, usage of current and past displayed content.

35. The method of claim 16, further comprising:
maintaining, with the processor, constant Internet and telephony interconnectivity.

36. The method of claim 16, wherein the desired content is provided by a back end user.

37. The method of claim 36, further comprising:
receiving, with the processor, payment from the back end user for displaying the desired content.
